(19) United States
(12) Patent Application Publication
(10) Pub. No.: US 2026/0359034 A1
(43) Pub. Date: Nov. 12, 2026

(54) METHOD AND APPARATUS FOR UPDATING ECU SOFTWARE OF VEHICLE

(71) Applicants: Hyundai Motor Company, Seoul (KR); Kia Corporation, Seoul (KR)

(72) Inventors: Chang Hun JUNG, Hwaseong-si, Gyeonggi-do (KR); Seung Wook PARK, Yongin-si, Gyeonggi-do (KR)

(73) Assignees: Hyundai Motor Company, Seoul (KR); Kia Corporation, Seoul (KR)

(21) Appl. No.: 19/515,128

(22) PCT Filed: Aug. 20, 2024
(86) PCT No.: PCT/KR2024/012357

§ 371 Date: Feb. 27, 2026

(30) Foreign Application Priority Data
Aug. 30, 2023 (KR) 10-2023-0114868
Aug. 8, 2024 (KR) 10-2024-0106219

(51) Int. Cl. G06F 8/65; H04L 9/32; H04L 9/40

(52) U.S. Cl. CPC G06F 8/65; H04L 9/3242; H04L 63/0442

(57) ABSTRACT

A method and apparatus for updating ECU software of vehicle are disclosed. According to an embodiment of a present disclosure, a method performed by a gateway for managing updates of one or more pieces of software installed in one or more electronic control units (ECUs) included in a vehicle, the method comprising: receiving an encrypted update module from an update server, decrypting the update module to obtain one or more update files, transmitting the one or more update files to each of the one or more ECUs and requesting a software update and receiving an update result report from the one or more ECUs in response to the request.

### CROSS-REFERENCE TO RELATED APPLICATIONS

This application claims priority from Korean Patent Application No. 10-2023-0114868 filed on Aug. 30, 2023, and Korean Patent Application No. 10-2024-0106219 filed on Aug. 8, 2024, the disclosures of which are incorporated by reference herein in their entirety.

### TECHNICAL FIELD

The present disclosure relates to a method and apparatus for updating ECU software of a vehicle. More specifically, the present disclosure relates to a method and apparatus for preventing security issues that may arise during an update of ECU software in a vehicle by clearly specifying the generator and generation time of encryption and authentication codes, as well as the type of encryption key, during the process of the vehicle receiving an update module or update file from a server.

### BACKGROUND ART

The content described below merely provides background information related to the present embodiment and does not constitute prior art.

To perform various autonomous traveling functions such as traveling safety, driver assistance, and autonomous traveling, many electronic devices or electrical components driven by an electronic control unit (ECU) are installed in a vehicle.

The electric control unit operates electrical components in the vehicle based on the software installed in the vehicle. The system of the vehicle updates the software installed in the vehicle to operate the electrical components more efficiently.

Over The Air (OTA) is a function that remotely updates in-vehicle software. Because the OTA is connected to wireless networks and the cloud, various security issues may arise. Malfunctions in the in-vehicle software due to external attacks can have devastating consequences for the vehicle and occupants in the vehicle. Therefore, when remotely updating the in-vehicle software, a method is needed to securely protect vehicle operating software or the like from external attacks.

### DISCLOSURE

### Technical Problem

A main object of the present disclosure is to provide a method and apparatus for protecting a vehicle connected to a network from external attacks.

A main object of the present disclosure is to provide a method and apparatus for ensuring confidentiality and integrity of software transmitted from a network to a vehicle.

A main object of the present disclosure is to provide a method and apparatus for preventing security issues that may occur during an update process that proceeds in the order of an automotive component supplier, a vehicle mobile gateway, and an electronic control unit (ECU).

Objects of the present invention are not limited to the objects mentioned above, and other objects not mentioned will be clearly understood by those skilled in the art from the description below.

### Technical Solution

According to at least one embodiment, the present disclosure provides a method for performed by a gateway for managing updates of one or more pieces of software installed in one or more electronic control units (ECUs) included in a vehicle. The method comprising: receiving an encrypted update module from an update server, decrypting the update module to obtain one or more update files, transmitting the one or more update files to each of the one or more ECUs and requesting a software update and receiving an update result report from the one or more ecus in response to the request.

According to another embodiment, the present disclosure provides a method performed by an electronic control unit (ECU) managing one or more pieces of software installed in a system in a vehicle, the method comprising: receiving an update request and an update file from a gateway, performing a software update using the update file and transmitting an update result report including a message indicating whether the update is successful to the gateway

According to another embodiment, the present disclosure provides a gateway for managing updates of one or more pieces of software installed in one or more electronic control units (ECUs) in a vehicle, the gateway comprising: at least one memory storing instructions; and at least one processor, wherein the at least one processor executes the instructions to receive an encrypted update module from an update server, decrypt the update module to obtain one or more update files, transmit the one or more update files to each of the one or more ECUs to request a software update and in response to the request, receive an update result report from the one or more ECUs

According to another embodiment, the present disclosure provides an electronic control unit (ECU) managing one or more pieces of software installed in a system in a vehicle, the ECU comprising: at least one memory storing instructions and at least one processor, wherein the at least one processor executes the instructions to receive an update request and an update file from a gateway, perform a software update using the update file and transmit an update result report including a message indicating whether the update is successful to the gateway.

### Advantageous Effects

According to one embodiment of the present disclosure, there is an effect of maintaining security by defending a vehicle from external attacks.

According to one embodiment of the present disclosure, there is an effect of maintaining security by protecting software transmitted to a vehicle from external attacks.

According to one embodiment of the present disclosure, there is an effect of ensuring the confidentiality and integrity of software transmitted to a vehicle.

According to one embodiment of the present disclosure, encrypted software is transmitted to the vehicle using the public key of the vehicle, and the encrypted software is decrypted using the private key of the vehicle, thereby enabling software to be updated without additional data exchange or procedures other than transmission of the encrypted software.

Effects of the present disclosure are not limited to the effects mentioned above, and other effects not mentioned will be clearly understood by those skilled in the art from the description below.

### DESCRIPTION OF DRAWINGS

FIG. 1 is a diagram conceptually illustrating a connection between a vehicle and a server using a network.

FIG. 2 is a block diagram schematically illustrating functional blocks constituting a vehicle connected to an external network.

FIG. 3 is a block diagram schematically illustrating the functional blocks constituting a gateway.

FIG. 4 is a diagram illustrating functions performed by a central control unit.

FIG. 5 is a block diagram schematically illustrating functional blocks constituting a server.

FIGS. 6a and 6b are diagrams illustrating a process for remotely updating ECU software according to the present disclosure.

FIG. 7 is a diagram illustrating in detail the process by which a gateway transmits an update application request and an update file to each ECU and receives an update application result report from the ECU.

FIG. 8 is a block diagram schematically illustrating an exemplary computing device that may be used to implement the method or apparatus according to the present disclosure.

### MODE FOR INVENTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe exemplary embodiments of the present invention, and is not intended to represent the only embodiments in which the present invention may be practiced.

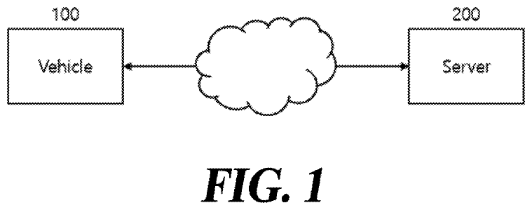

FIG. 1 is a diagram conceptually illustrating a connection between a vehicle 100 and a server 200 using a network. The vehicle 100 may be connected to the server 200 using a mobile network or wireless network such as LTE, 5G, or Wi-Fi. The server 200 may provide functions or services related to the vehicle 100.

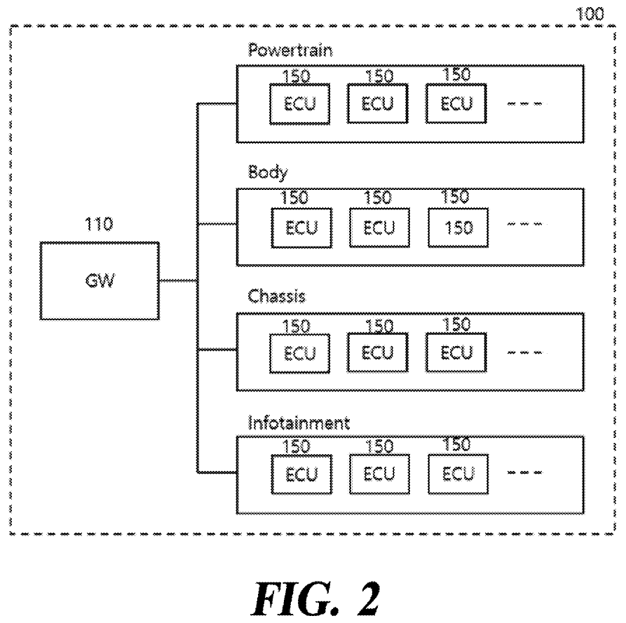

FIG. 2 is a block diagram schematically illustrating functional blocks that constitute the vehicle 100 connected to an external network. The vehicle 100 may include a gateway (GW) 110 and subsystems.

The gateway 110, that is, a vehicle mobile gateway (VMG), is connected to the external network and internal network. The subsystems are connected to the internal network of the vehicle 100. The subsystems may include a powertrain subsystem, a body subsystem, a chassis subsystem, an infotainment subsystem, and the like.

The subsystem is a collection of components with similar functions connected via the same internal bus, containing one or more electrical components. Each electrical component may be controlled and driven by its own electronic control unit (ECU) 150.

The powertrain subsystem is a collection of components that generate driving force of the vehicle, and may include components such as an engine, motor, transmission, battery, and generator. The body subsystem is a collection of components that enhance passenger comfort and safety, and may include components such as seats, heating, ventilation, and air conditioning (HVAC), lighting, doors, windows, and interior and exterior lighting. The chassis subsystem is a collection of components necessary for vehicle traveling, excluding the body, and may include components related to steering, brakes, suspension, and tire pressure measurement. The infotainment subsystem is a collection of components related to traveling guidance or multimedia, and may include components such as navigation, multimedia systems, and head-up displays.

The internal network connecting the gateway 110 and the electrical components constituting the subsystems may use communication protocols such as a Local Interconnect Network (LIN), Control Area Network (CAN), CAN-FD, FlexRay, Media Oriented Systems Transport (MOST), and Ethernet. Electrical components of other subsystems using different communication protocols may exchange data with each other by utilizing the gateway 110.

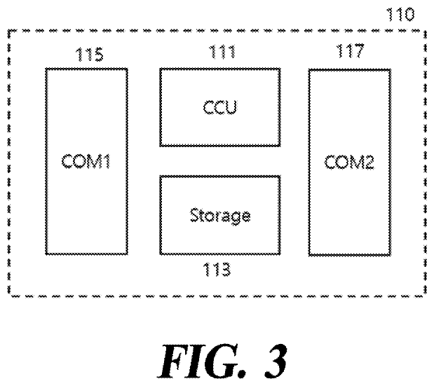

FIG. 3 is a block diagram schematically illustrating the functional blocks that constitute the gateway 110. The gateway 110 may include a central control unit (CCU) 111, a storage 113, an external communication unit (COM1) 115, and an internal communication unit (COM2) 117.

The central control unit (CCU) 111 may control the overall operation of the vehicle. The storage 113 may store data received from the external network and internal network, or data or information related to the operation of the vehicle. The external communication unit (COM1) 115 may connect the server 200 and the gateway 110 using the external network. The internal communication unit (COM2) 117 may connect the electrical components (ECUs) of the subsystem and the gateway 110 using the internal network.

The central control unit 111, internal communication unit 117, and separate storage may be configured as separate devices separated from the gateway 110.

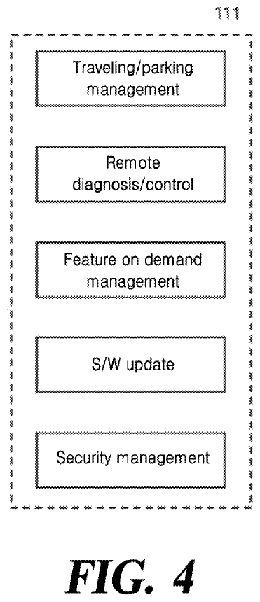

FIG. 4 is a diagram illustrating the functions performed by the central control unit 111.

The central control unit 111 may control various operations of the vehicle 100 by controlling the ECU 150 of at least one electrical component included in at least one subsystem according to a request from a passenger, a need due to a traveling situation, or the like.

The functions performed by the central control unit 111, particularly functions performed based on data transmitted using the external network and/or internal network, may include traveling/parking management, remote diagnosis/control, feature on demand management, software update, security management, or the like.

The remote diagnosis/control is a function that transmits status information collected while the vehicle is in operation to the server 200 to diagnose the vehicle in real time, and changes the control conditions of the vehicle based on the diagnosis results received from the server 200 or supports remote control in an emergency.

The feature on demand (FOD) management is a function that manages a type of feature on demand, such as downloading and activating a new feature through a server 200 or a customer's terminal, or activating and using a feature that is already installed but deactivated.

The central control unit 111 performs the setup or cancellation of the feature on demands. The central control unit 111 may verify whether the service requested by the customer is a service activated by the customer's subscription selection or whether the feature on demand is activated through fraudulent means, and perform or not perform the service based on the verification result.

The software update is a service automatically performed by the central control unit 111 when software update conditions are met in the vehicle to which OTA is applied. The software update may include updating not only the software (operating system of the central control unit 111) that manages the operation of the entire vehicle, but also the firmware installed in the ECU 150 of each electrical component.

The security management may include functions or services related to vehicle security or authentication of external devices connecting to the vehicle.

Security threats related to vehicles may include firmware tampering, remote vehicle control hacking, CAN tampering, vehicle tampering, denial of service, and the like. The security threats related to the external network communications may also include communication interception, message tampering, or the like.

The security management may perform functions (IDS; Intrusion Detection System) such as detecting and responding to intrusions into the internal network of the vehicle through the external network, an event service (EDR: Event Data Recorder) for data (data immediately before a security incident) related to security events, or the like.

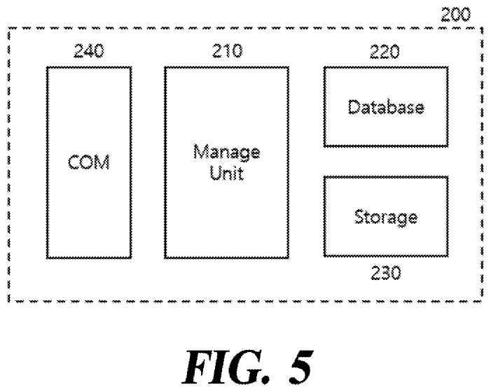

FIG. 5 is a block diagram schematically illustrating the functional blocks that constitute the server 200. The server 200 may include a manager 210, a database 220, a storage 230, and a communication unit (COM) 240.

The manager 210 may manage operations according to vehicle requests, such as software updates, data transmission related to FOD, or vehicle security/authentication. The database 220 may manage information related to each vehicle, such as software versions installed in each vehicle, activated feature on demands, authentication-related information, or the like. The storage 230 may store various versions of software, data related to traveling of multiple vehicles, or the like. The communication unit (COM) 240 may connect to the vehicle 100 using an external network and exchange data.

The server 200 may include a plurality of different servers, each of which is distinguished according to the function or service performed by the central control unit 111 of the vehicle 100. The database 220 may also be installed separately from the server 200.

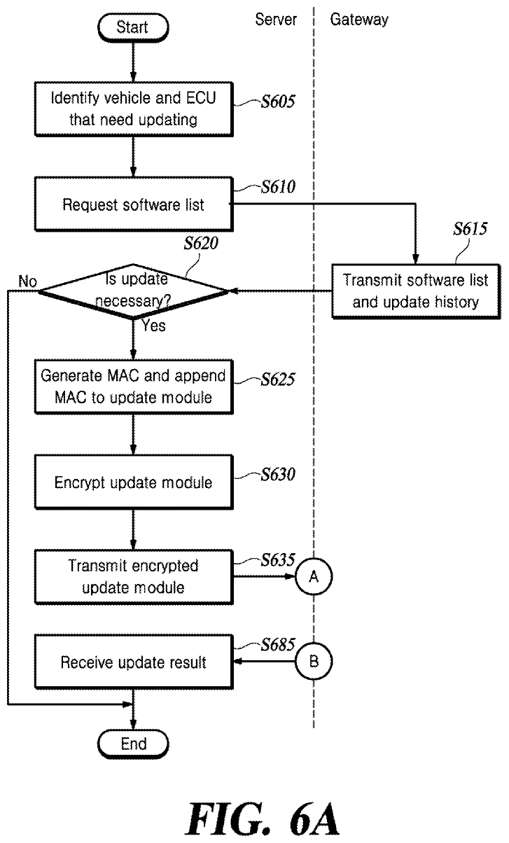

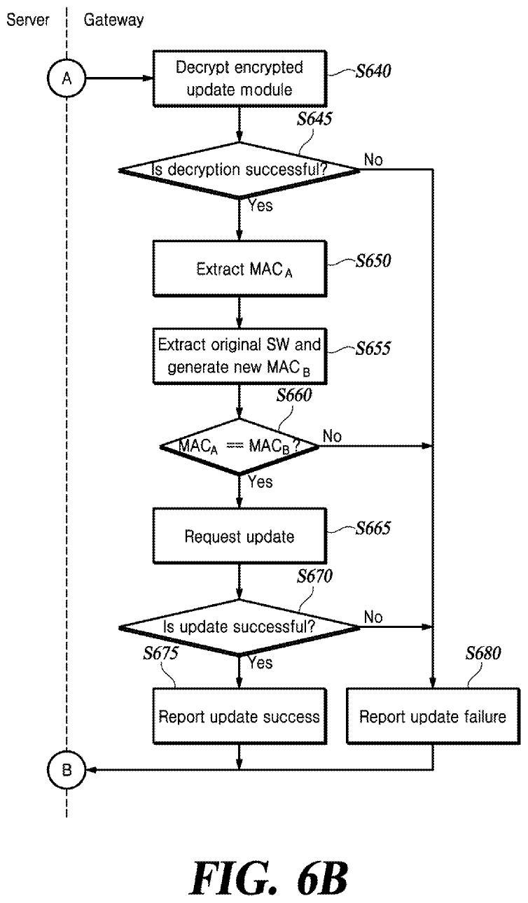

FIGS. 6a and 6b are diagrams illustrating a process for remotely updating ECU software according to the present disclosure. The communication between the server 200 and the gateway 110 may utilize a secure channel based on Transport Layer Security (TLS).

The server 200 may identify the ECUs and vehicles equipped with relevant software to determine which vehicles and ECUs require the software updates (S605). The server 200 may identify the ECUs equipped with relevant software using the serial number (S/N) assigned to the ECU at the time of manufacturing. The server 200 may identify the vehicle equipped with the relevant software using a vehicle identification number (VIN).

The server 200 may request the software information of the vehicle 100 from the gateway 110 of the vehicle 100 equipped with the relevant software (S610). The software information may include information regarding the version of the software installed in each ECU.

The gateway 110 may transmit data including the list of software installed in each ECU and an update history of each software, particularly the version of the software, to the server 200 (S615).

The server 200 may check the update history of each software installed in the vehicle 100 based on the data received from the gateway 110 and determine which older versions of the software require the update (S620). When no software requires an update (S620—NO), the server 200 terminates the update process.

When there is software that requires an update (S620—NO), the server 200 may generate a message authentication code (MAC) using the symmetric key and the update module (S625). The symmetric key is a key already shared between the server 200 and the gateway 110. The update module includes an update file. The server 200 may append the MAC to the update module.

The server 200 may encrypt the binary file of the update module with the MAC appended using the public key of the gateway 110 (S630). The server 200 may transmit the encrypted update module to the gateway 110 (S635).

The gateway 110 may decrypt the encrypted update module using the private key of the gateway 110 (S640). The gateway 110 may decrypt the encrypted update module using the hardware security module (HSM) and the private key of the gateway 110.

When the update module decryption fails (S645—NO), the gateway 110 may transmit an update result report including an update failure message to the server 200 (S680). When the update module decryption succeeds (S645—YES), the gateway 110 may obtain MACA which is MAC appended to the update module by the server 200 from the decrypted data (S650).

The gateway 110 may obtain the original update module from the decrypted data and generate MACB using the original update module and the symmetric key (S655). The symmetric key is a key already shared by the server 200 and the gateway 110, and is the key used by the server 200 when generating the MAC.

The gateway 110 may compare the MACA and MACB (S660). When the MACA and MACB are different (S660—NO), the gateway 110 may transmit the update result report including the update failure message to the update server 200 (S680). When the MACA and MACB are the same (S660—YES), the gateway 110 may transmit the update application request and the update file to each ECU 150 requiring the update, and then receive the update application result report from the ECU 150 (S665).

When the update application fails (S670—NO), the gateway 110 may transmit the update result report including the update failure message to the update server 200 (S680). When the update application succeeds (S670—YES), the gateway 110 may transmit the update result report including the update success message to the update server 200 (S675). The server 200 may receive the update result report from the gateway 110 and terminate the update process (S685).

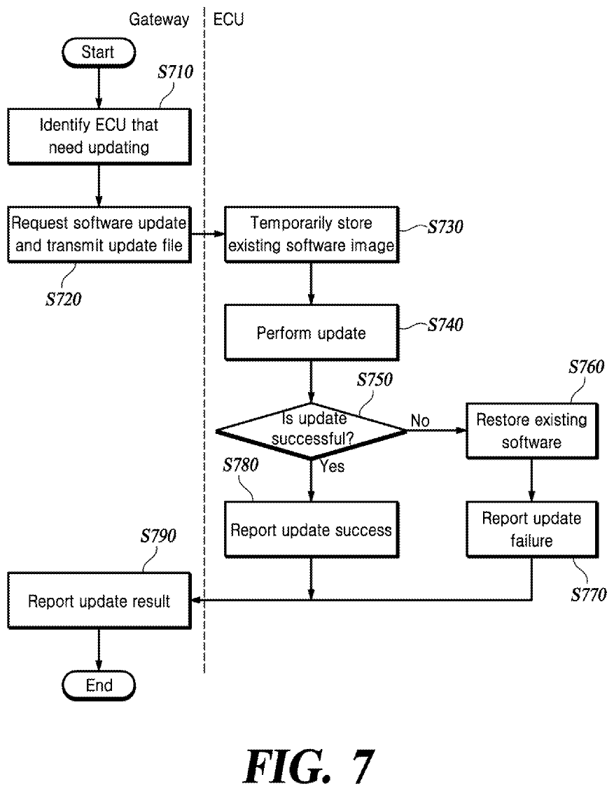

FIG. 7 is a diagram for explaining in detail the process (S665) in which the gateway 110 transmits the update application request and the update file to each ECU 150 and receives the update application result report from the ECU 150.

The gateway 110 may identify the ECU 150 that needs to perform the software update (S710). The gateway 110 may transmit the decrypted update file along with the software update request to each ECU 150 that needs the update (S720).

The ECU 150 that receives the software update request may store the previously installed software in internal or external storage for rollback purposes (S730). The ECU 150 may temporarily store the existing software image in the internal or external storage for rollback purposes. The software image is a single object including files required for application execution.

The ECU 150 may perform the software update using the update file (S740). The ECU 150 may determine whether the update is successful (S750). When the update fails (S750—NO), the ECU 150 may restore the existing software using a software image stored in the storage (S760). The ECU 150 may transmit the update result report including the update failure message to the gateway 110 (S790). When the update is successful (S750—YES), the ECU 150 may transmit the update result report including the update success message to the gateway 110 (S780).

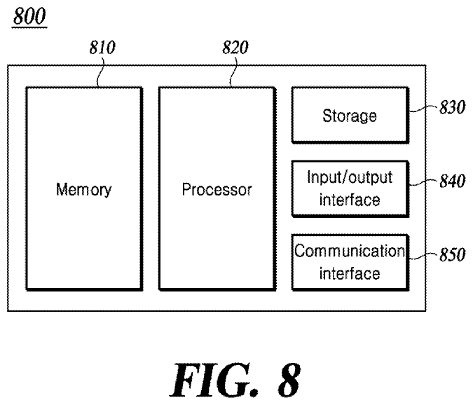

FIG. 8 is a block diagram schematically illustrating an exemplary computing device that may be used to implement the method or apparatus according to the present disclosure.

A computing device 800 may include some or all of a memory 810, a processor 820, storage 830, an input/output interface 840, and a communication interface 850. The computing device 800 may structurally and/or functionally include at least a portion of a device according to the present disclosure. The computing device 800 may be a stationary computing device, such as a desktop computer or a server, as well as a mobile computing device, such as a laptop computer, a smart phone, or an automotive electronic device. The computing device 800 may also be implemented with any specialized hardware accelerator capable of efficiently processing operations for an artificial intelligence model. For example, the computing device 800 may include a graphic processing unit (GPU), a Tensor Processing Unit (TPU), or a neural processing unit (NPU).

The memory 810 may store a program that causes the processor 820 to perform a method or operation according to various embodiments of the present disclosure. For example, the program may include a plurality of instructions executable by the processor 820, and the above-described method or operation may be performed by executing the plurality of instructions by the processor 820. The memory 810 may be a single memory or a plurality of memories. In this case, information required to perform the method or operation according to various embodiments of the present disclosure may be stored in a single memory or may be divided and stored in a plurality of memories. When the memory 810 includes a plurality of memories, the plurality of memories may be physically separated. The memory 810 may include at least one of a volatile memory and a non-volatile memory. The volatile memory includes a static random access memory (SRAM) or a dynamic random access memory (DRAM), and the non-volatile memory includes a flash memory.

The processor 820 may include at least one core capable of executing at least one instruction. The processor 820 may execute instructions stored in the memory 810. The processor 820 may be a single processor or multiple processors.

The storage 830 maintains stored data even when power supplied to the computing device 800 is cut off. For example, the storage 830 may include non-volatile memory, or may include storage media such as magnetic tape, optical disk, or magnetic disk. A program stored in storage 830 may be loaded into memory 810 before being executed by processor 820. The storage 830 may store a file written in a programming language, and a program generated from the file by a compiler or the like may be loaded into the memory 810. The storage 830 may store data to be processed by the processor 820 and/or data processed by the processor 820.

The input/output interface 840 may provide an interface with an input device such as a keyboard, mouse, or the like and/or an output device such as a display device, printer, or the like. The user may trigger the execution of a program by the processor 820 through the input device and/or check the processing result of the processor 820 through the output device.

The communication interface 850 may provide access to an external network. The computing device 800 may communicate with other devices via the communication interface 850.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Accordingly, one of ordinary skill would understand that the scope of the claimed invention is not to be limited by the above explicitly described embodiments but by the claims and equivalents thereof.

1. A method performed by a gateway for managing updates of one or more pieces of software installed in one or more electronic control units (ECUs) included in a vehicle, the method comprising:
receiving an encrypted update module from an update server;
decrypting the update module to obtain one or more update files;
transmitting the one or more update files to each of the one or more ECUs and requesting a software update; and
receiving an update result report from the one or more ECUs in response to the request.

2. The method of claim 1, wherein the update module is shared using an asymmetric key encryption method.

3. The method of claim 1, wherein receiving the update module comprises:
receiving the encrypted update module using a public key of the gateway.

4. The method of claim 1, further comprising:
receiving a first message authentication code from the update server;
generating a second message authentication code based on the update module; and
determining whether to request the software update based on a result of comparing the first message authentication code with the second message authentication code.

5. The method of claim 4, wherein the first message authentication code is transmitted in combination with the update module.

6. The method of claim 1, wherein the gateway is communicatively connected to the update server using a secure channel based on transport layer security (TLS).

7. A method performed by an electronic control unit (ECU) managing one or more pieces of software installed in a system in a vehicle, the method comprising:
receiving an update request and an update file from a gateway;
performing a software update using the update file; and
transmitting an update result report including a message indicating whether the update is successful to the gateway.

8. The method of claim 7, further comprising:
temporarily storing existing software; and
restoring the temporarily stored existing software when the software update fails.

9. A gateway for managing updates of one or more pieces of software installed in one or more electronic control units (ECUs) in a vehicle, the gateway comprising:
at least one memory storing instructions; and
at least one processor,
wherein the at least one processor executes the instructions to
receive an encrypted update module from an update server,
decrypt the update module to obtain one or more update files,
transmit the one or more update files to each of the one or more ECUs to request a software update, and
in response to the request, receive an update result report from the one or more ECUs.

10. The gateway of claim 9, wherein the update module is shared with the update server using an asymmetric key encryption method.

11. The gateway of claim 9, wherein the update module is an encrypted update module using a public key of the gateway.

12. The gateway of claim 9, wherein, to determine whether to request the software update, the at least one processor executes the instructions to:
receive a first message authentication code from the update server,
generate a second message authentication code based on the update module, and
compare the first message authentication code with the second message authentication code.

13. The gateway of claim 12, wherein the first message authentication code is transmitted in combination with the update module.

14. The gateway of claim 9, wherein the gateway is communicatively connected to the update server using a secure channel based on TLS.

15-16. (canceled)
